(19) United States
(12) Patent Application Publication
(10) Pub. No.: US 2002/0008774 A1
(43) Pub. Date: Jan. 24, 2002

(54) Prompter and signal processing device therefor

(76) Inventors: Kunio Yata, Saitama-shi (JP); Masayoshi Wasada, Saitama-shi (JP)

Correspondence Address: BIRCH STEWART KOLASCH & BIRCH, PO BOX 747, FALLS CHURCH, VA, 22040-0747, US

(21) Appl. No.: 09/908,723

(22) Filed: Jul. 20, 2001

(30) Foreign Application Priority Data
Jul. 21, 2000 (JP) 2000-221000
Jul. 21, 2000 (JP) 2000-221001
Sep. 19, 2000 (JP) 2000-283843

(51) Int. Cl. H04N 5/225

(52) U.S. Cl. 348/375

(57) ABSTRACT

A prompter has a half-silvered mirror and a monitor, and the monitor displays a residual amount of a battery for the prompter. When the residual amount is less than a predetermined amount, a warning is displayed to a user in order to replace the battery. If the battery is exhausted, a camera battery supplies power to the prompter instead of the prompter battery.

### BACKGROUND OF THE INVENTION

1. Field of the Invention

The present invention relates to a prompter and its signal processing device, and particularly to a prompter which displays a script image, etc. for a person who works in front of a camera and its signal processing device.

2. Description of the Related Art

A prompter displays a script on a monitor to allow a newscaster to read the script displayed on the monitor as if he or she knew the script from memory by looking at a TV camera. The monitor is facing up in front of the bottom of a taking lens, and a half-silvered mirror is mounted in front of the taking lens at a 45-degrees angle to the monitor. The half-silvered mirror reflects the script image form the monitor toward the newscaster without interfering with the shooting of the newscaster (Japanese Patent Application Laid-open No. 1147970). A prompter that has a liquid crystal display for a script image beside a taking lens without a half-silvered mirror is also known (Japanese Patent Application Laid-open No. 7170430).

A signal processing device for a prompter that records a script image in an embedded memory before the shooting and outputs the recorded script image to the monitor at the shooting is also known.

The signal processing device outputs not only the recorded script image but also an image the camera is capturing and a real-time image on the air. The newscaster can check his or her appearance and the like before the shooting and check the camera during the shooting with the prompter.

Conventionally, a special device that displays characters “NEWSCASTER CUE” indicating that an image of the newscaster is on the air is used for the newscaster. A special device that displays characters “NOTICE FU” indicating that voice of the newscaster is on the air is also used for the newscaster.

A rechargeable battery is used for the prompter at a place where there is no power source such as a news-gathering scene. The battery can be exhausted during the shooting. In this case, the reporter needs to replace the battery and shoot again. When the reporter goes to a news-gathering scene and shoots alone, the reporter checks the standing position and appearance by looking at an image on the monitor the camera is capturing and rehearse by displaying the script image on the monitor. This exhausts the battery before the shooting, and the battery easily is exhausted during the shooting. A battery has an indicator that indicates a residual amount of it, but the reporter needs to move to the prompter to check the residual amount.

The reporter also needs to work as a cameraman. The reporter can not adjust conditions (a zoom, an aperture, a type of an ND filter, and a type of a color filter) of the camera alone by looking at a viewfinder (electronic viewfinder). Even if the reporter can adjust them with a remote control, the viewfinder shows the current condition, and the reporter can not check them at the standing position.

Making the special device for the easy noticeability is time consuming, and it is a problem where to put the special device. In case an assistant holds it or it is put in a studio, the special device or the assistant can be in the shooting area. If the special device is away from the shooting area, the newscaster can not see that.

### SUMMARY OF THE INVENTION

The present invention has been developed in view of the above-described circumstances, and has as its object the provision of a prompter that prevents a battery for the prompter from being exhausted during a shooting.

Moreover, the present invention provides a signal processing device of a prompter that enables a person who works in front of a camera to check conditions of a camera at a standing position for a shooting without looking at a viewfinder.

Furthermore, the present invention provides a prompter which can display a message that is noticeable for a person who works in front of a camera such as a newscaster.

In order to achieve the above-described objects, the present invention is directed to a prompter which displays a script image on a monitor for a person in front of a camera, the prompter comprising: a battery residual amount determining device that determines a residual amount of a battery for the prompter; and a battery information displaying device that displays battery information on the monitor according to the residual amount determined by the battery residual amount determining device.

The battery information is the residual amount of the battery or a warning when the residual amount is less than a predetermined amount.

The prompter further comprises a power input terminal connected to a power source other than the battery, and the power source supplies power to the prompter through the power input terminal when the residual amount of the battery determined by the battery residual amount determining device is less than a predetermined amount. The prompter may further comprises a power input terminal connected to a power source other than the battery, the battery information is one of the residual amount of the battery and a warning when the residual amount is less than a first predetermined amount, and the power source supplies power to the prompter through the power input terminal when the residual amount of the battery determined by the battery residual amount determining device is less than a second predetermined amount.

According to the present invention, since the monitor displays the residual amount of the battery or the warning when the residual amount is less than a predetermined amount, the person can replace the battery before it is exhausted. If the person uses the prompter before the shooting, he or she can be cautious in order to prevent the battery from being exhausted during the shooting.

When the residual amount is less than the predetermined amount, the power source other than the battery supplies the power to the prompter. This prevents the battery from being exhausted during the shooting.

The present invention is also directed to a signal processing device of a prompter that outputs video signals to a monitor on which a script image is displayed for a person in front of a camera, the signal processing device comprising: a first input terminal through which video signals of an image that one of the camera and another camera is capturing are inputted to the signal processing device; a second input terminal through which video signals of an image that an electronic viewfinder is displaying are inputted to the signal processing device; and a switching device that switches the video signals to be outputted to the monitor between the video signals inputted through the first input terminal and the video signals inputted through the second input terminal.

The electronic viewfinder displays information on conditions of the camera, and the monitor displays the information when the video signals inputted through the second input terminal is outputted to the monitor by the switching device.

According to the present invention, since the monitor can display the image the camera is capturing and the image the electronic viewfinder is displaying, the person can easily check the conditions of the camera at the standing position for the shooting without looking at the electronic viewfinder.

The present invention is also directed to a prompter which displays a script image on a monitor for a person in front of a camera, wherein the monitor displays a message for the person.

The message informs the person that one of an image and voice of the person is on the air.

According to the present invention, the monitor displays the message for the person. For example, the message informs the person that the image or voice of the person is on the air. A special device does not need to be made, and where and how to put the special device do not need to be determined.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a view showing a news-gathering shooting with a TV camera using a prompter of the present invention;

FIG. 2 is a block diagram showing a structure for displaying battery information on a monitor;

FIGS. 3(A), 3(B), 3(C), 3(D) and 3(E) show characters and diagrams indicating residual amounts of a battery displayed on the monitor;

FIG. 4 is a block diagram shows a structure of a battery switching part of the prompter in which two batteries are switched;

FIG. 5 is a view showing a news-gathering shooting with the TV camera using the prompter of the present invention;

FIG. 6 is a view showing the monitor when video signals are outputted from a viewfinder to the monitor;

FIG. 7 is a block diagram showing a circuit of a signal processing device of the prompter;

FIG. 8 is a view showing a newscast shooting with a TV camera using a prompter;

FIG. 9 is a view showing a message for a newscaster;

FIG. 10 is a view showing a message for the newscaster; and

FIG. 11 is a block diagram showing a circuit of a signal processing device for the newscaster.

### DETAILED DESCRIPTION OF THE PREFERRED EMBODIMENTS

Hereunder preferred embodiments of the present invention will be described in detail in accordance with the accompanying drawings.

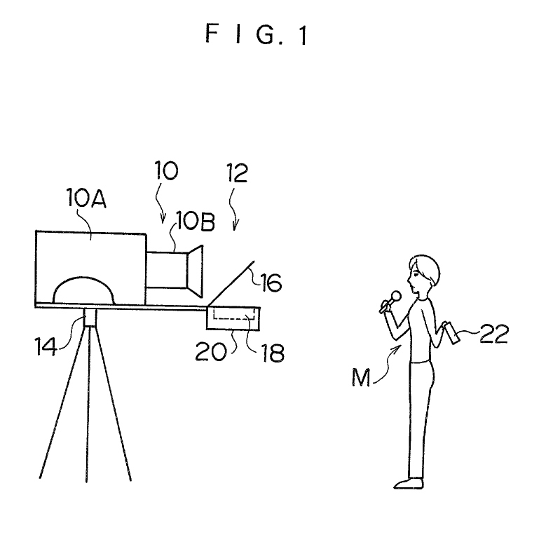

FIG. 1 shows a news-gathering shooting with a TV camera 10 using a prompter 12 of the present invention. Suppose a case in which a reporter M (person) goes to a news-gathering scene and reads a script displayed on the prompter 12 in front of the TV camera 10 alone. The TV camera 10 (a camera body 10A and a taking lens 10B) is mounted on a pedestal 14, and the prompter 12 is provided in front of the TV camera 10 on the pedestal 14.

The prompter 12 is composed of a monitor 18 facing up and a half-silvered mirror 16 mounted at a 45-degrees angle to the monitor 18 in front of the taking lens 10B. A casing 20 for the monitor 18 contains devices and circuits including a signal processing device 32 (not shown). The signal processing device 32 records an image (such as a script image) to be displayed on the monitor 18 as inputted video signals in an embedded memory, or outputs an image recorded in the memory to a video signal input terminal of the monitor 18 as video signals. The signal processing device 32 switches video signals to be outputted to the video signal input terminal of the monitor 18 between video signals inputted from the outside in real time and the video signals stored in the memory according to operation of a remote control 22 that the reporter M is holding.

The operation of the reporter M before and during the shooting will now be explained. First, the reporter M connects a video signal output terminal of the TV camera 10 with a video signal input terminal on the casing 20 through a cable. This inputs video signals outputted from the TV camera 10 to the signal processing device 32. The reporter M shoots a sheet of a manuscript with the TV camera 10 to input the video signals to the signal processing device 32. Then, the reporter M stores the video signals in the memory with the remote control 22. The reporter M repeats the recording for each sheet of the manuscript. Alternatively, the reporter M records a script made with a personal computer in the memory. In this case, the reporter M connects a video signal output terminal of the personal computer with the video signal input terminal of the prompter 12 through a cable, and inputs the video signals to the signal processing device 32.

Next, the reporter M connects the video signal output terminal of the TV camera 10 with the video signal input terminal on the casing 20 through the cable to input video signals outputted from the TV camera 10 to the signal processing device 32. The reporter M also outputs the video signals from the signal processing device 32 to the monitor 18. This makes the monitor 18 display the real-time image the TV camera 10 is capturing. The reporter M checks his or her standing position and appearance by looking at the reflected image on the half-silvered mirror 16. At the same time, the reporter M operates, the TV camera 10 to adjust the view angle and so on with the remote control 22 (or another remote control). If the reporter M wants to rehearse, the reporter M outputs the video signals recorded in the memory to the monitor 18 to display the script image on the monitor 18 with the remote control 22. Then, the reporter M scrolls and reads the script to confirm the shooting time, etc.

After the preparation is finished, the shooting starts. The reporter M outputs the video signals stored in the memory to the monitor 18 with the remote control 22 to display the script image on the monitor 18. Next, the reporter M starts the recording of the TV camera 10 with the remote control 22, and scrolls and reads the script displayed by the prompter 12. After reading the entire script, the reporter M stops the recording of the TV camera 10 with the remote control 22 to end the shooting.

One or more rechargeable batteries (storage batteries) can be used for the TV camera 10 and the prompter 12 since there is no power source at the news-gathering scene. In this case, one battery is connected to a power input terminal on the casing 20, and the power is supplied to the monitor 18, the signal processing device 32, etc. of the prompter 12. Generally, each of the TV camera 10 and the prompter 12 has one battery, but they may share one battery.

In the case where the battery is used for the prompter 12, the battery is used before the shooting, and can be exhausted during the shooting. To address this problem, the monitor 18 displays a residual amount of the battery as battery information. Alternatively, it displays a warning as the battery information when the residual amount is less than a predetermined amount. This informs the reporter M of that the battery is going to be exhausted before the battery is exhausted. In case the reporter M prepares for the shooting, the prompter 12 informs the reporter M that the battery is going to be exhausted before the shooting. Thus, the reporter M can prevent the battery from being exhausted during the shooting by taking a measure such as a replacement of the battery.

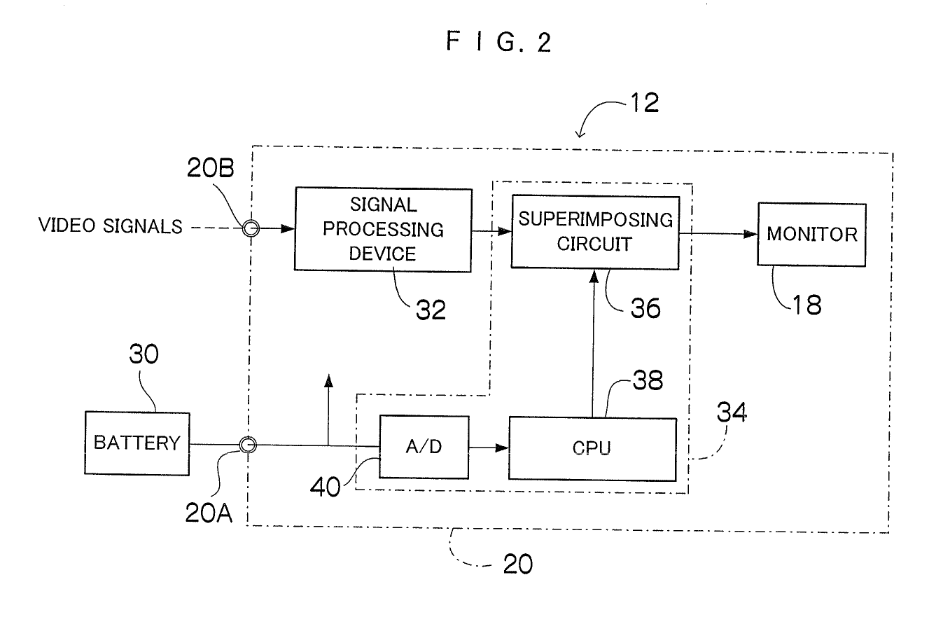

FIG. 2 is a block diagram showing a structure for displaying the battery information on the monitor 18. The power input terminal 20A on the casing 20 is connected to the battery 30 through the cable, and the power is supplied to the devices and the circuits of the prompter 12. The casing 20 contains not only the signal processing device 32 and the monitor 18 but also a superimposing device 34 that displays the battery information on the monitor 18.

The signal processing device 32 records the image (the script image) as the video signals inputted through the video signal input terminal 20B on the casing 20 in the embedded memory (image memory), or outputs the image recorded in the memory as the video signals to the monitor 18. The signal processing device 32 switches the video signals to be outputted to the monitor 18 between the video signals stored in the memory and the video signals inputted through the video signal input terminal 20B in real time.

The video signals are stored and switched according to operation of the remote control 22 or a switch on the casing 20 or the like. The signal processing device 32 may be separate from the prompter 12.

The superimposing device 34 comprises a superimposing circuit 36 that superimposes signals of the battery information on the video signals outputted from a video signal output terminal of the signal processing device 32 and outputs the superimposed signals to the video signal input terminal of the monitor 18, a CPU 38 that designates characters or a diagram to be displayed for the superimposing circuit 36, and an A/D converter 40 that converts the voltage applied through the power input terminal 20A into a digital voltage and applies the digital voltage to the CPU 38. Since superimposition of characters or a diagram on an image is widely known, the structure of the superimposing circuit 36 is not shown in detail. The superimposing device 34 may be integrated with the signal processing device 32.

When the power of the prompter 12 is on, the CPU 38 of the superimposing device 34 obtains the voltage from the battery 30 through the A/D converter 40 and determines the residual amount of the battery 30. Then, the CPU 38 designates the characters or the diagram of the battery information according to the residual amount. If the CPU 38 knows the relation between the voltage and the residual amount of the battery 30, it does not have to calculate the residual amount from the voltage. Thus, the CPU 38 may designate the battery information according to the voltage.

First, the case where the residual amount of the battery 30 is displayed as the battery information will be explained. The CPU 38 determines the characters or the diagram according to the residual amount, and commands the superimposing circuit 36 to superimpose the signals of the characters or the diagram on the video signals outputted from the signal processing device 32 and output the superimposed signals to the monitor 18. The CPU 38 designates the position, the size, the color, etc. of the characters or the diagram for the superimposing circuit 36.

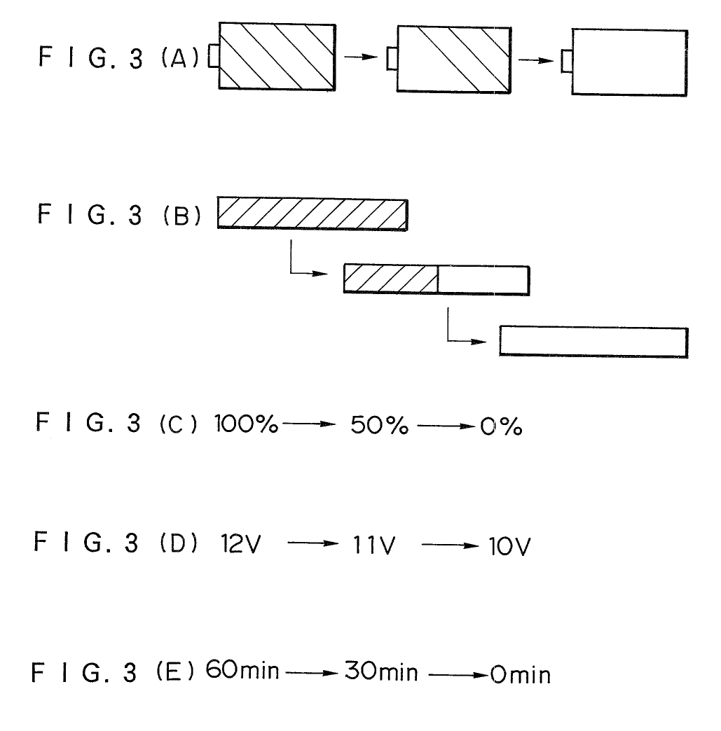

FIGS. 3(A), 3(B), 3(C), 3(D) and 3(E) show characters and diagrams indicating residual amounts of the battery 30 displayed on the monitor 18. Each figure shows three steps from the full-charged battery to the exhausted battery. FIG. 3,(A) shows battery-shaped diagrams, and a black area of each diagram indicates the residual amount. FIG. 3(B) shows bar-shaped diagrams, and a black area of each diagram indicates the residual amount. FIG. 3(C) shows percentages of the residual amounts, and FIG. 3(D) shows voltages of the battery 30, and FIG. 3(E) shows remaining time of the battery 30. Other diagrams and characters may be used to indicate the residual amount of the battery 30.

The residual amount does not need to be displayed all the time, and it may be displayed only when the residual amount is low or the reporter M commands the prompter 12 to display the residual amount with the remote control 22 or the like. In case of the all-the-time display, the residual amount may be inconspicuously displayed (for example, it is displayed in a comer of the monitor 18 in a small size, and an inconspicuous color, density and brightness) when the residual amount is large, and it may be conspicuously displayed (for example, it is displayed in the center of the monitor 18 in a large size, and an conspicuous color, density and brightness) when the residual amount is small.

Next, the case in which the warning is displayed as the battery information when the residual amount is less than the predetermined amount (threshold) will be explained. When the residual amount is less than the predetermined amount (or the voltage is less than the predetermined voltage), the CPU 38 commands the superimposing circuit 36 to superimpose the signals of the warning characters or diagram on the video signals outputted from the signal processing device 32 and output the superimposed signals to the monitor 18. The CPU 38 designates the position, the size, the color, etc. of the characters or the diagram for the superimposing circuit 36.

The warning preferably starts to be displayed when the residual amount is enough for the shooting. The threshold may be determined according to the average time of shootings, and the reporter M may determine it on the basis of the shooting time. The reporter M may freely determine it.

The warning may be the characters such as “REPLACE BATTERY” or the diagram such as a lamp-shaped diagram. When the residual amount is less than the threshold, the remaining time of the battery 30 may be displayed all the time or at predetermined times. A warning screen is displayed on the whole monitor 18 instead of the superimposed warning. In this case, the prompter 12 can not be used until the reporter M turns off the warning screen with the remote control 22 or the like. Both the residual amount and the warning may be displayed, and the reporter M may determine whether or not he or she wants to display each of them.

The residual amount or the warning displayed on the monitor 18 can prevent the battery 30 from being exhausted during the shooting.

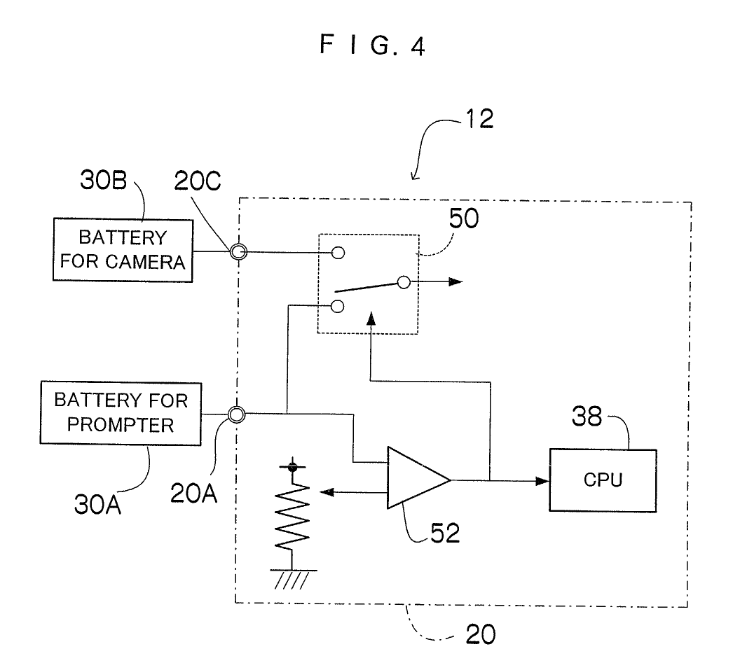

The case in which the two batteries are switched will now be explained. FIG. 4 shows a structure of a battery switching part of the prompter 12. The monitor 18, the signal processing device 32 and the superimposing device 34 (excluding the CPU 38) are not shown in FIG. 4. The casing 20 of the prompter 12 has the power input terminal 20A connected to the battery 30A for the prompter 12 and a power input terminal 20C connected to the battery 30B for the camera. A battery other than the battery 30A may be connected to the power input terminal 20C instead of the battery 30B. A switch 50 is provided in the casing 20, and the power is supplied from the batteries 30A and 30B to the devices and the circuits of the prompter 12 through the switch 50.

A comparator 52 compares the voltage of the battery 30A with a reference voltage. If the voltage of the battery 30A is higher than the reference voltage (the residual amount is larger than a predetermined amount), the comparator 52 outputs a Low signal to put the switch 50 on the battery 30A side. Thus, the power is supplied from the battery 30A to the devices and the circuits of the prompter 12.

If the voltage of the battery 30A is the reference voltage or lower (the residual amount is the predetermined amount or smaller), the comparator 52 outputs a High signal to put the switch 50 on the battery 30B side. Thus, the power is supplied from the battery 30B to the devices and the circuits of the prompter 12.

The batteries 30A and 30B can be switched just before the battery 30A is exhausted.

The switch of the batteries 30A and 30B can prevent the battery 30A from being exhausted during the shooting.

The comparator 52 outputs the Low signal or the High signal to the CPU 38 of the superimposing device 34. If the CPU 38 detects that the Low signal is switched to the High signal, it commands the superimposing circuit 36 (see FIG. 2) to superimpose signals of characters or a diagram indicating the switch of the batteries 30A and 30B on the video signals and output the superimposed signals to the monitor 18. The monitor displays the characters or the diagram, and this informs the reporter M of the switch of the batteries 30A and 30B. The reporter M also knows that they need to replace the battery 30A for the prompter 12. The battery which is being used may be also displayed on the monitor 18. The voltages of the batteries 30A and 30B may be inputted to the CPU 38 in order to enable the residual amounts of the batteries 30A and 30B and the warnings to be also displayed.

Another embodiment will now be explained.

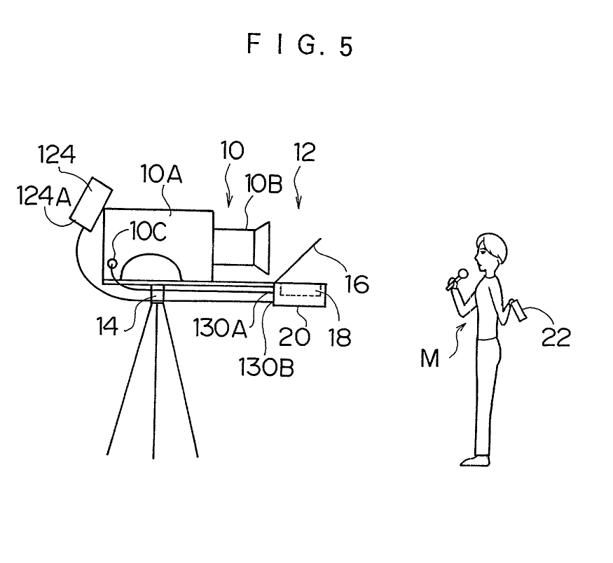

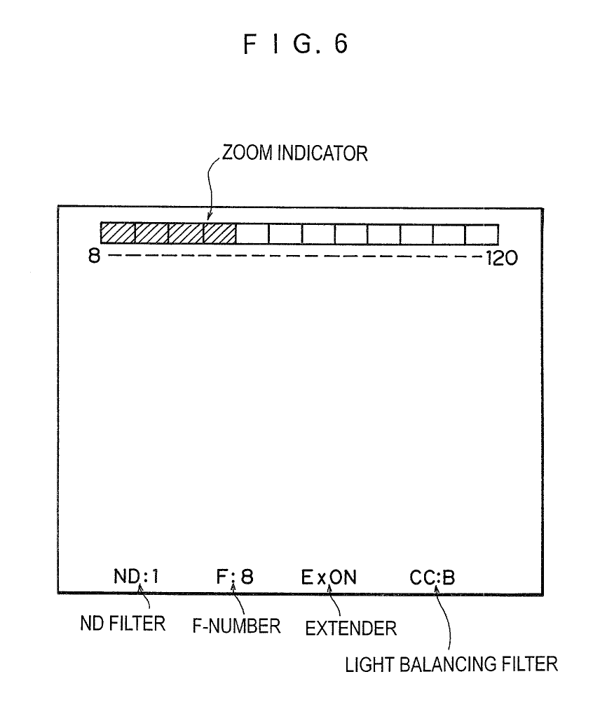

The casing 20 for the monitor 18 contains devices and circuits including a signal processing device 130 (not shown) in FIG. 5. The signal processing device 130 has two video signal input terminals 130A and 130B. The video signal input terminal 130A is connected to the video signal output terminal 10C of the camera body 10A through a cable, and the video signals that the taking lens 10 is capturing are inputted to the video signal input terminal 130A. The video signal input terminal 130B is connected to a video signal output terminal 124A of an electronic viewfinder 124 of the camera 10 through a cable, and video signals of an image displayed on the viewfinder 124 are outputted to the video signal input terminal 130B.

The signal processing device 130 also has a video signal output terminal 130C that is connected to the video signal input terminal of the monitor 18. The monitor 18 displays an image of video signals outputted from the signal processing device 130.

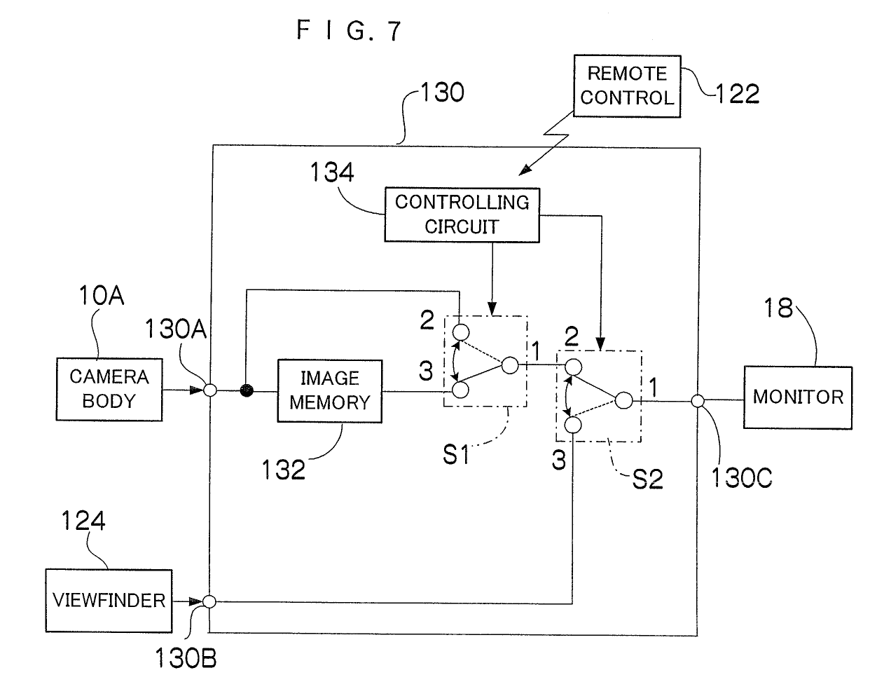

The video signals to be outputted from the signal processing device 130 to the monitor 18 are switched between the real-time video signals inputted from the camera 10 to the video signal input terminal 130A, the real-time video signals inputted from the viewfinder 124 to the video signal input terminal 130B, and video signals of an image (such as a script image) recorded in an embedded image memory 132 (see FIG. 7). The image memory 132 can record an image of the video signals inputted from the camera 10 (or another camera) to the video input terminal 130A of the signal processing device 130. For example, the camera 10 shoots the manuscript to be read and the image memory 132 records the script image before the shooting.

FIG. 6 shows the monitor 18 when the video signals are outputted from the viewfinder 124 to the monitor 18. The monitor 18 displays the same image as the viewfinder 124 displays, and the image is composed in such a manner that information on conditions of the camera body 10A and the taking lens 10B (information on conditions of the camera 10) is superimposed on the image the camera 10 is capturing. A bar-shaped zoom indicator is displayed on the top of the screen to indicate the current zoom position. A type of an ND filter (code), an F-number, whether or not an extender is being used and a type of a light balancing filter (code) are displayed on the bottom of the screen. The information displayed on the viewfinder 124 and the monitor 18 is not limited to this.

The operation of the reporter M before and during the shooting will now be explained. First, the reporter M sets the camera 10 and the prompter 12 at the news-gathering scene as shown in FIG. 5. Then, the reporter M shoots a sheet of the manuscript with the camera 10 to input the video signals to the signal processing device 130, and stores the video signals in the image memory 132 with the remote control 122. The reporter M repeats the recording for each sheet of the manuscript. The reporter M may record the script before the setting of the camera 10.

Next, the reporter M outputs the video signals from the camera 10 to the monitor 18 with the remote control 122. This causes the monitor 18 to display the real-time image the camera 10 is capturing. The reporter M checks his or her standing position and appearance by looking at the reflected image on the half-silvered mirror 16. Then, the reporter M outputs the video signals from the viewfinder 124 to the monitor 18 with the remote control 122. This makes the monitor 18 display the real-time image the viewfinder 124 is displaying as shown in FIG. 6. This enables the reporter M to adjust the conditions (the zooming, the aperture, the type of the ND filter, the type of the color filter, and so on) of the camera 10 at the standing position by looking at the image displayed on the monitor 18. Therefore, the reporter M does not need to move to the viewfinder 124 of the camera body 10A.

After the preparation is finished, the shooting starts. The reporter M outputs the video signals stored in the image memory 132 to the monitor 18 with the remote control 122 to display the script image on the monitor 18. Next, the reporter M starts the recording of the camera 10 with the remote control 122, and scrolls and reads the script displayed by the prompter 12. After reading the entire script, the reporter M stops the recording of the camera 10 with the remote control 122 to end the shooting.

A video signal output terminal of a camera (script camera for shooting the script may be connected to the video signal input terminal 130A of the signal processing device 130. This makes it possible to shoot the script with the script camera in real time and display the script image on the monitor 18. Another remote control may be used instead of the remote control 122.

FIG. 7 shows a circuit of the signal processing device 130 of the prompter 12. The signal processing device 130 has the video signal input terminal 130A connected to the camera body 10A, the video signal input terminal 130B connected to the viewfinder 124, and the video signal output terminal 130C connected to the monitor 18.

The video signal input terminal 130A is directly connected to a terminal 2 of a switch S1, and connected to a terminal 3 of the switch S1 through the image memory 132. A terminal 1 of the switch S1 is connected to the terminal 2 or the terminal 3 according to a command from a controlling circuit 134, and connected to a terminal 2 of a switch S2. A terminal 1 of the switch S2 is connected to the terminal 2 or a terminal 3 according to a command from the controlling circuit 134, and connected to the video signal output terminal 130C. The video signal input terminal 130B is connected to the terminal 3 of the switch S2.

When the reporter M commands the prompter 12 to display the image the camera 10 is capturing with the remote control 122, the controlling circuit 134 receives the command by wireless or wire and outputs the video signals from the camera body 10A to the monitor 18 by connecting the terminal 1 of the switch S1 with the terminal 2 and connecting the terminal 1 of the switch S2 with the terminal 2. This displays the image the camera 10 is capturing on the monitor 18. If the reporter M commands the prompter 12 to record the image in the image memory 132 with the remote control 122, the controlling circuit 134 stores the video signals inputted through the video signal input terminal 130A as digital data (image data) in the image memory 132. FIG. 7 does not show a processing circuit that converts the video signals into the image data.

If the reporter M commands the prompter 12 to display the image recorded in the image memory 132 with the remote control 122, the controlling circuit 134 connects the terminal 1 of the switch S 1 with the terminal 3 and connects the terminal 1 of the switch S2 with the terminal 2. This outputs the image data stored in the image memory 132 to the monitor 18 as the video signals, and the monitor 18 displays the script image. FIG. 7 does not show a processing circuit that converts the video signals into the image data.

If the reporter M commands the prompter 12 to display the image which the viewfinder 124 is displaying with the remote control 122, the controlling circuit 134 can not operate the switch S1 and that connects the terminal 1 of the switch S2 with the terminal 3. This outputs the video signals from the viewfinder 124 to the monitor 18, and the monitor 18 displays the image the viewfinder 124 is displaying. Since the viewfinder 124 shows the conditions of the camera 10 (the camera body 10A and the taking lens 10B) with the image the camera 10 is capturing, the reporter M can adjust the conditions by looking at the monitor 18.

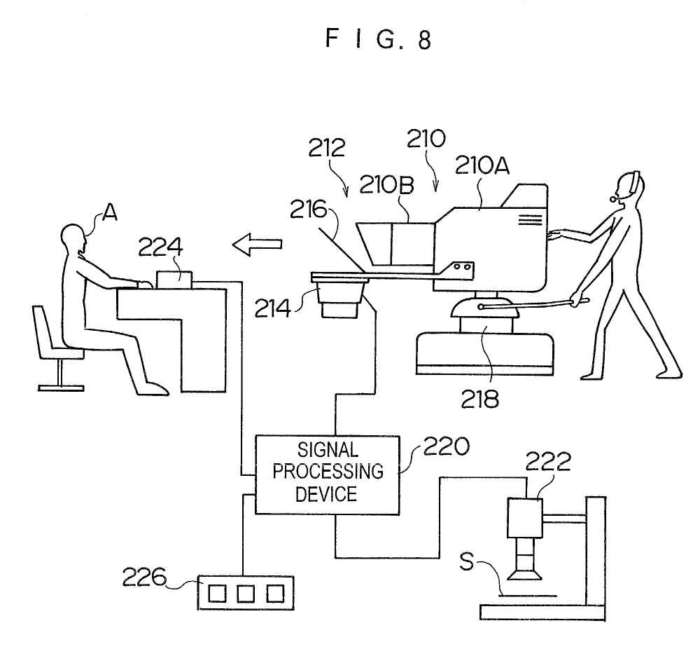

FIG. 8 shows a newscast shooting with a TV camera 210 using a prompter 212. Suppose a case in which a newscaster A (person) sits in front of the TV camera 210 (a camera body 210A and a taking lens 210B) and reads a script displayed on the prompter 212 in front of the taking lens 210B of the TV camera 210. The prompter 212 is composed of a monitor 214 facing up in front of the taking lens 210B and a half-silvered mirror 216 mounted at a 45degrees angle to the monitor 214. The monitor 214 and the half-silvered mirror 216 are mounted on a pan head 218 for the camera body 210A or the TV camera 210.

A video signal input terminal of the monitor 214 is connected to a video signal output terminal of a signal processing device 220, and the monitor 214 displays an image of video signals outputted from the signal processing device 220. The signal processing device 220 and the monitor 214 may be in one casing, and they may be separate.

The signal processing device 220 has one or more video signal input terminals. One of them is connected to a video signal output terminal of a script camera 222 that shoots a script S to be read, and video signals are outputted from the script camera 222 to the monitor 214 through the signal processing device 220. This displays a script image on the monitor 214. In case the signal processing device 220 has two or more video signal input terminals, the newscaster A can choose video signals with a control part 224 at hand. For example, the newscaster A may choose video signals of an image on the air, video signals outputted from the TV camera 210, or the video signals outputted from the script camera 222.

The image (such as the script image) inputted to the signal processing device 220 as the video signals can be recorded in a memory in the signal processing device 220, and the recorded video signals or the video signals inputted to the signal processing device 220 in real time may be outputted to the monitor 214. Thus, the script camera 222 can shoot the script and the memory of the signal processing device 220 can record the script image before the newscast shooting, and the monitor 214 can display the recorded script image at the shooting. The newscaster A can scroll the script with the control part 224 at hand when he or she reads it.

When the monitor 214 displays the image such as the script image, the image is reflected into the half-silvered mirror 216 so that the newscaster A can look at the reflected image without looking away from the TV camera 210.

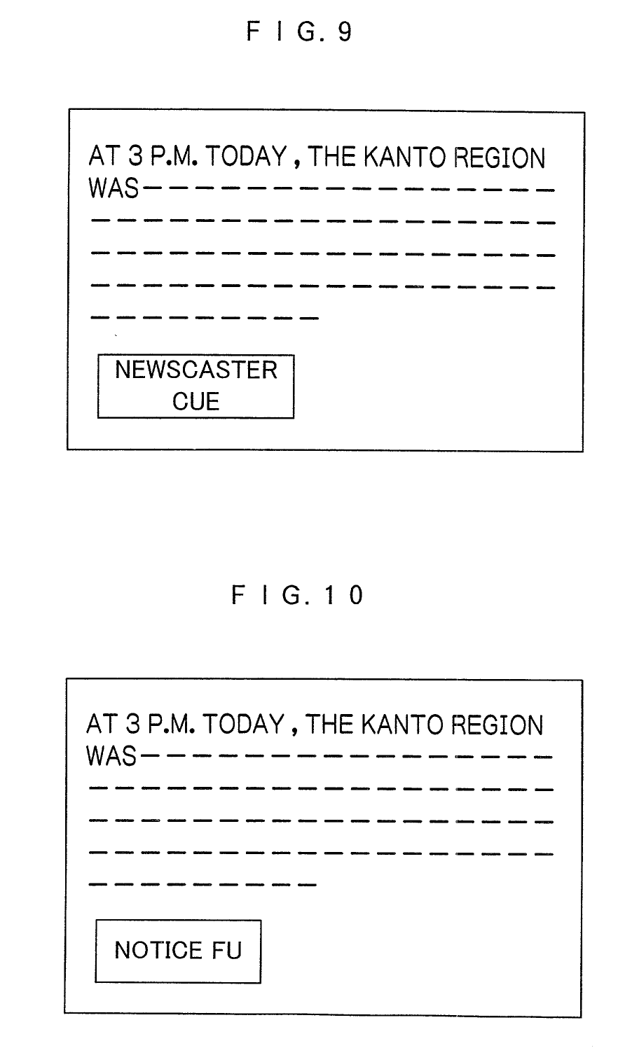

The signal processing device 220 has an easy-noticeability function that displays messages for the newscaster. The messages include characters “NEWSCASTER CUE” for informing the newscaster A that the image of him or her is on the air and characters “NOTICE FU” for informing the newscaster A that his or her microphone is on. Video signals of the characters are superimposed on the video signals of the script image or the like so that the characters are displayed on the monitor 214 with the script image or the like. The characters “NEWSCASTER CUE” are displayed in the lower left hand comer of the script screen as shown in FIG. 9, and the characters “NOTICE FU” are displayed in the lower left hand corner of the script screen as shown in FIG. 10. A director or someone else can turn on and off the easy-noticeability function with a switch of a control part 226 connected to the signal processing device 220 by wire or wireless or a switch on the casing of the signal processing device 220. The message is noticeable for the newscaster when he or she is reading the script. Since the messages are displayed on the monitor 214, the camera 210 does not shoot unneeded objects.

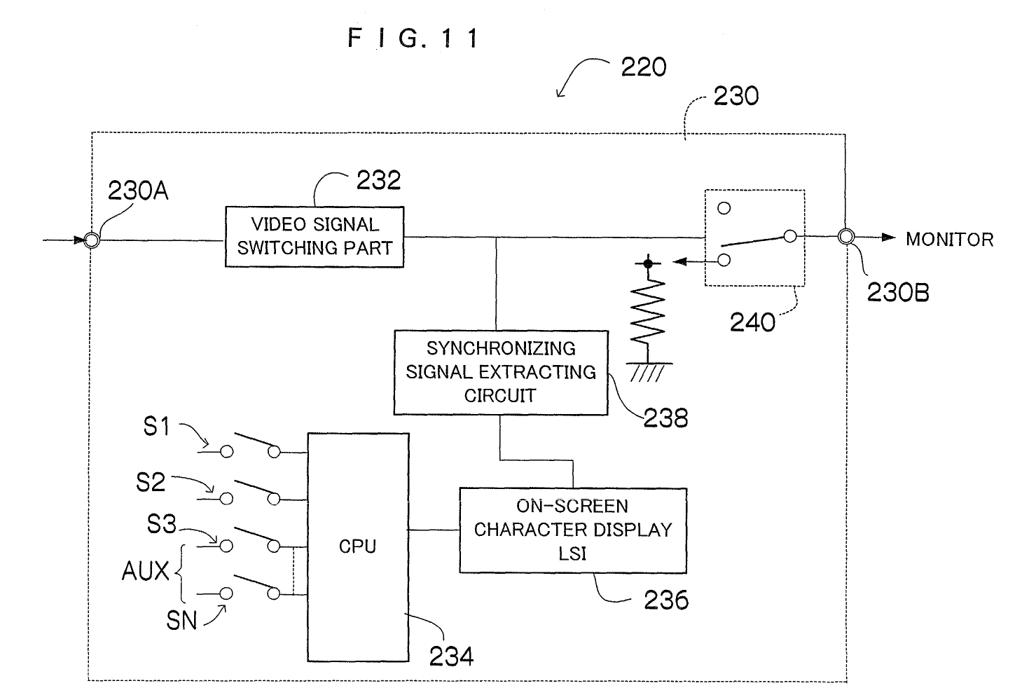

FIG. 11 is a block diagram showing a circuit of the signal processing device 220. The casing 230 of the signal processing device 220 has the video signal input terminal 230A connected to the script camera 222, etc. and the video signal output terminal 230B connected to the video signal input terminal of the monitor 214. The casing 230 may have two or more video signal input terminals. The signals that pass the video signal input terminal 230A and the video signal output terminal 230B may be composite video signals such as NTSC signals, or component signals such as RGB signals.

The video signals inputted through the video signal input terminal 230A are inputted to a video signal switching part 232 with the memory that records the script image and so on. The video signal converting part 232 stores the video signals inputted through the video signal input terminal 230A in the memory, outputs the video signals stored in the memory, and switches the video signals to be outputted through the video signal output terminal 230B between the stored video signals and the video signals inputted through the video signal input terminal 230A in real time in accordance with a command from a control part (for example, the control part 224 in FIG. 8). The video signals outputted from the video signal converting part 232 is outputted to the monitor 214 through a video switch 240 and the video signal output terminal 230B.

The signal processing device 220 also has a CPU 234 that superimposes the messages on the script image, an on-screen character display LSI 236, a synchronizing signal extracting circuit 238 and the video switch 240. The casing 230 or the control part 226 in FIG. 8 has switches S, S2, S3, . . . , SN for choosing the messages, and the CPU 234 determines whether the switches are S1-SN on or off by wire or wireless. For example, the switch S1 is for the message “NEWSCASTER CUE,” and the switch S2 is for the message “NOTICE FU.” The other switches S3-SN are auxiliary switches, and a message needs to be registered in the CPU 234 for each of them.

When the CPU 234 detects that one of the switches S1-SN has been turned on, the CPU 234 commands the on-screen character display LSI 236 to superimpose the message on the script image. The command indicates codes for the characters, the size, the position, the color, etc. of the message. If two or more switches are turned on at one time, the CPU 234 determines the arrangement of the messages. The user may send a signal (a signal used for turning on a tally lamp) indicating that the image of the newscaster A is on the air to the CPU 234 instead of turning on the switch S1. The user may directly command the on-screen character display LSI 236 with a personal computer.

Horizontal synchronizing signals and vertical synchronizing signals of the video signals extracted by the synchronizing signal extracting circuit 238 are inputted to the on-screen character display LSI 236.

The on-screen character display LSI 236 outputs superimposition signals for superimposing the message on the script image to the video switch 240 in synchronization with the video signals according to the command from the CPU 234 and the synchronizing signals from the synchronizing signal extracting circuit 238.

The video switch 240 is put not on a video signal switching part side but a brightness level side only when the video switch 240 receives the superimposition signals so that the CPU 234 superimposes the message on the script image. The video switch 240 may be incorporated in the on-screen character display LSI 236. In case of color message, if the video signals are composite signals, the video signals are converted into RGB signals, and a signal is superimposed on each of the RGB signals, and then the composed signals are converted into composite signals.

The superimposed video signals are outputted from the video signal output terminal 230B to the video signal input terminal of the monitor 214 of the prompter 212. This superimposes the messages such as “NEWSCASTER CUE” and “NOTICE FU” on the script image as shown in FIGS. 9 and 10.

The messages are characters in the embodiment, but they may be diagrams or marks. The prompter 212 can make the message conspicuous by making it flicker, reversing the brightnesses of the message and its circumference, or changing its color to a conspicuous color such as red.

The prompter 212 may display how long the newscaster A has before the start or end of the shooting as a message. For example, the user turns on a switch to display characters “30 SECONDS” when the newscaster A has thirty seconds left, and the CPU 234 counts down.

In case there are two or more newscasters and each of them has a script image, the script images are switched in response to an operation of a newscaster switch indicating who is the next. However, it is hard to determine whose script image is being displayed. For this reason, the number of a script image that is being displayed may be displayed in response to the operation of the newscaster switch.

As has been described above, since the monitor displays the residual amount of the battery or the warning when the residual amount is less than a predetermined amount, the person can replace the battery before it is exhausted. If the person uses the prompter before the shooting, he or she can be cautious in order to prevent the battery from being exhausted during the shooting.

When the residual amount is less than the predetermined amount, the power source other than the battery supplies the power to the prompter. This prevents the battery from being exhausted during the shooting.

As has been described above, since the monitor can display the image the camera is capturing and the image the electronic viewfinder is displaying, the person can easily check the conditions of the camera at the standing position for the shooting without looking at the electronic viewfinder.

As has been described above, the monitor displays the message for the person. For example, the message informs the person that the image or voice of the person is on the air. A special device does not need to be made, and where and how to locate the special device do not need to be determined. This also prevents unneeded objects from being shot during the shooting.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A prompter which displays a script image on a monitor for a person in front of a camera, said prompter comprising:
a battery residual amount determining device that determines a residual amount of a battery for the prompter; and
a battery information displaying device that displays battery information on the monitor according to the residual amount determined by the battery residual amount determining device.

2. The prompter as defined in claim 1, wherein the battery information is one of the residual amount of the battery and a warning when the residual amount is less than a predetermined amount.

3. The prompter as defined in claim 1, further comprising:
a power input terminal connected to a power source other than the battery,
wherein the power source supplies power to the prompter through the power input terminal when the residual amount of the battery determined by the battery residual amount determining device is less than a predetermined amount.

4. The prompter as defined in claim 1, further comprising:
a power input terminal connected to a power source other than the battery,
wherein the battery information is one of the residual amount of the battery and a warning when the residual amount is less than a first predetermined amount,
wherein the power source supplies power to the prompter through the power input terminal when the residual amount of the battery determined by the battery residual amount determining device is less than a second predetermined amount.

5. A signal processing device of a prompter that outputs video signals to a monitor on which a script image is displayed for a person in front of a camera, said signal processing device comprising:
a first input terminal through which video signals of an image that one of the camera and another camera is capturing are inputted to the signal processing device;
a second input terminal through which video signals of an image that an electronic viewfinder is displaying are inputted to the signal processing device; and
a switching device that switches the video signals to be outputted to the monitor between the video signals inputted through the first input terminal and the video signals inputted through the second input terminal.

6. The signal processing device as defined in claim 5, wherein:
the electronic viewfinder displays information on conditions of the camera; and
the monitor displays the information when the video signals inputted through the second input terminal are outputted to the monitor by the switching device.

7. A prompter which displays a script image on a monitor for a person in front of a camera, wherein the monitor displays a message for the person.

8. The prompter as defined in claim 7, wherein the message informs the person that one of an image and voice of the person is on the air.
